(19) United States
(12) Patent Application Publication
(10) Pub. No.: US 2018/0374510 A1
(43) Pub. Date: Dec. 27, 2018

(54) IMAGE PROCESSING DEVICE, AND OPERATION METHOD FOR IMAGE PROCESSING DEVICE

(71) Applicant: SAMSUNG ELECTRONICS CO., LTD., Suwon-si, Gyeonggi-do (KR)

(72) Inventors: Nam-jae JEON, Seoul (KR); Jae-ook KWON, Yongin-si, Gyeonggi-do (KR)

(21) Appl. No.: 15/781,626

(22) PCT Filed: Dec. 8, 2016
(86) PCT No.: PCT/KR2016/014357

§ 371 Date: Jun. 5, 2018

(30) Foreign Application Priority Data
Dec. 10, 2015 (KR) 10-2015-0176279

(51) Int. Cl. G11B 20/18; G11B 20/10; G11B 20/12; H04N 5/76

(52) U.S. Cl. CPC G11B 20/1883; G11B 20/10527; G11B 2020/1222; H04N 5/7605; G11B 2220/2516; G11B 20/1217

(57) ABSTRACT

Disclosed are: an image processing device; an operation method for the image processing device; and a computer-readable recording medium. According to an embodiment of the present disclosure, the operation method for the image processing device, which can be connected to a storage medium storing a file system, can comprise the steps of: communicating with a storage medium; storing, in a file system, logic information on the bad sector of the storage medium; and blocking the bad sector from accessing data on the basis of the logic information when recording data in the storage medium or reading the recorded data according to a request of a user.

### TECHNICAL FIELD

Apparatuses and methods consistent with the disclosure relate to an image processing device, an operation method for the image processing device, and a computer-readable recording medium, and more particularly, to an image processing device for enabling a storage medium such as a hard disk to be easily used by managing a bad sector of the storage medium, an operation method for the image processing device, and a computer-readable recording medium.

### BACKGROUND ART

A Hard Disk Driver (HDD) disk is a disk capable of storing massive data, may be connected to and used in a general PC according to a SATA method or a USB method, and is portable. Since an HDD is used in a PC and is a portable device, a bad sector easily occurs in the HDD disk due to workload of data processing according to damages caused by impacts or a mass storage of contents. This bad sector is classified into a physical bad sector which is not physically used any more and a logic bad sector which occurs due to an error of simple firmware.

There is a function of restoring such a bad sector by finding and marking the bad sector of the HDD disk and blocking the bad sector from being accessed any more in a window with a Norton Disk Doctor (NDD) of a PC HDD. Similarly, a function using the same method is embodied in an offline Bad Block Management (BBM) file system tool on Linux, and a user or a product finds out a problematic sector by reading and writing all sectors of the HDD disk by using the corresponding tool.

A Megabyte (MB) HDD used 20 years ago develops into Gigabyte 10 years ago and into Terabyte at present. When considering MB as a unit in the old days, checking all sectors by using offline BBM may not be a problem. However, at present time welcoming TB age, if the corresponding tool operates in a TB HDD, a few days may be taken for obtaining results. Therefore, loading the corresponding tool in an embedded product requiring a fast response may be an inappropriate solution in terms of user.

Also, in an age where a size of image data gradually increases with a mass storage of contents and an increase in a resolution, a bad sector of a HDD may be a big problem for a picky user.

For example, if a user records and uses TV broadcasts for a week with a scheduled recording function by connecting an HDD disk with a PVR function of a TV, there is a high possibility that a bad sector will occur due to a large amount of data writing. If a bad sector occurs, a user who enjoys using scheduled recording accesses the bad sector in a process of deleting and re-recording a recorded file. Therefore, since scheduled recording stops every time due to a stop of an application (App) operation or error processing, the user has a problem of not appropriately using the corresponding function.

### DETAILED DESCRIPTION OF THE INVENTION

### Technical Problem

The disclosure provides an image processing device for enabling a storage medium such as a hard disk to be easily used by managing a bad sector of the storage medium, an operation method for the image processing device, and a computer-readable recording medium.

### Technical Solution

According to an aspect of the disclosure, an operation method for an image processing device connectable to a storage medium storing a file system, includes communicating with the storage medium, storing logic information on a bad sector of the storage medium in the file system, and blocking the bad sector from accessing data based on the logic information when recording data in the storage medium or reading the recorded data according to a request of a user.

The file system may include an error block storing the logic information of the bad sector.

The operation method may further include generating the error block in the file system when the file system is mounted in the image processing device.

The operation method may further include determining a bad type of the bad sector, wherein managing of the file system includes managing the logic information of the bad sector having physical badness caused by a physical impact of the storage medium.

The determining of the bad type of the bad sector includes determining whether the bad type is logic badness caused by an error in data processing.

The operation method may further include processing the logic information of the bad sector determined as the logic badness in a data accessible state in the file system.

The bad type may be determined as the logic badness when recording test data in the bad sector and normally reading the recorded test data.

The bad type of the bad sector may be determined when the image processing device in an idle state.

The managing in the file system may include managing logic information on a surrounding sector of the bad sector determined as the physical badness together.

A determination as to whether the error occurs may be performed with respect to a plurality of normal sectors including the bad sector in real time.

According to another aspect of the disclosure, an image processing device connectable to a storage medium storing a file system, includes a communication interface unit configured to communicate with the storage medium, and a processor configured to store logic information on a bad sector of the storage medium in the file system and block the bad sector from accessing data based on the logic information when recording data in the storage medium or reading the recorded data according to a request of a user

The file system may include an error block (bad inode) storing the logic information of the bad sector.

The processor may generate the error block in the file system when the file system is mounted in the image processing device.

The processor may determine a bad type of the bad sector and manage the logic information of the bad sector when the bad type is physical badness caused by a physical impact of the storage medium.

The processor may further determine whether the bad type is logic badness caused by an error in data processing.

The processor may process the logic information of the bad sector determined as the logic badness in a data accessible state in the file system.

The processor may determine the bad type as the logic badness when recording test data in the bad sector and normally reading the recorded test data.

The processor may determine the bad type when the processor is in an idle state.

The processor may manage logic information on a surrounding sector of the bad sector determined as the physical badness together.

The image processing device of claim 14, wherein a determination as to whether the error occurs may be performed with respect to a plurality of normal sectors including the bad sector in real time.

According to another aspect of the disclosure, a computer-readable recording medium includes a program for executing an operation method for an image processing device. The operation method may include communicating with a storage medium of data, managing logic information on a bad sector of the storage medium, in which an error occurs, in the file system when recording data in the storage medium or reading the recorded data according to a request of a user, and blocking the bad sector from accessing data based on the logic information managed by in the file system.

### DESCRIPTION OF THE DRAWINGS

FIG. 1 is a view illustrating a system for processing a bad sector of a storage medium according to an exemplary embodiment of the disclosure.

FIG. 2 is a view illustrating a file structure of a file system according to an exemplary embodiment of the disclosure.

FIG. 3 is a view illustrating a process of a system for processing a bad sector of a storage medium.

FIG. 4 is a view illustrating an error occurrence situation

FIG. 5 is a block diagram illustrating a detailed structure of an image processing device of FIG. 1.

FIG. 6 is a block diagram illustrating another detailed structure of the image processing device of FIG. 1.

FIG. 7 is a view illustrating a structure of a microcomputer circuit unit of FIG. 6

FIG. 8 is a flowchart illustrating a process of operating an image processing device according to an exemplary embodiment of the disclosure.

FIG. 9 is a flowchart illustrating a process of driving an image processing device according to another exemplary embodiment of the present invention.

### MODE OF THE INVENTION

Hereinafter, exemplary embodiments of the disclosure will be described in detail with reference to the drawings.

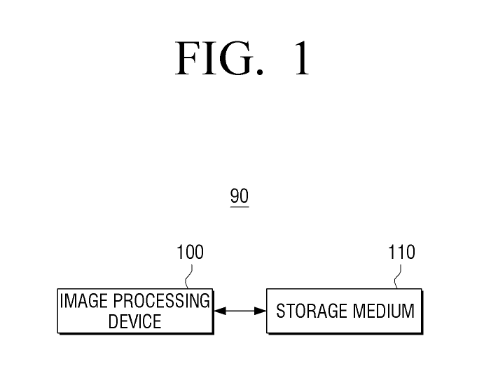

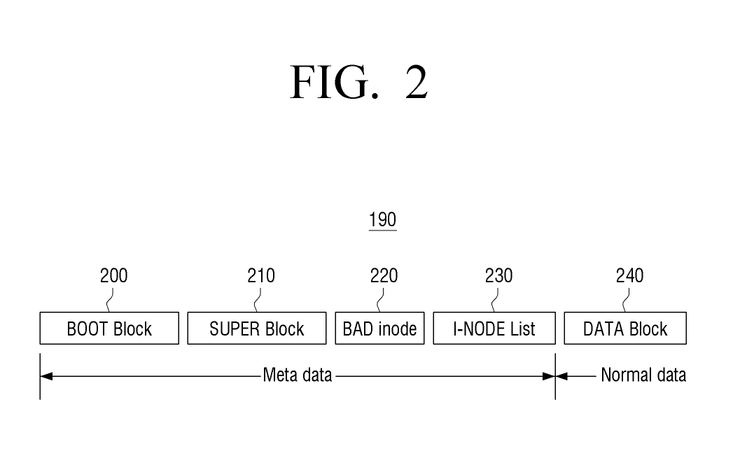

FIG. 1 is a view illustrating a system for processing a bad sector of a storage medium according to an exemplary embodiment of the disclosure. FIG. 2 is a view illustrating a file structure of a file system according to an exemplary embodiment of the disclosure.

As shown in FIG. 1, a system 90 for processing a bad sector of a storage medium according to an exemplary embodiment includes some or all of an image processing device 100 and a storage medium 110.

Here, the “inclusion of some or all” means that the storage medium 110 may be included in the image processing device 110 and will be described as including all for helping sufficient understanding of the disclosure.

The storage medium 110 which is portable or mobile is connected to the image processing device 100 according to the exemplary embodiment of the disclosure. Examples of the image processing device 100 includes image processing devices such as a smartphone, a DTV, a smart TV, a laptop computer, a desktop computer, a tablet PC, and the like and may further include media devices such as a set-top box (STB), a VCR, a Bluray Disk (BD) player, and the like. Here, the laptop computer, the desktop computer, and the table PC may process image data and text data such as documents, and thus the image processing device 100 according to the exemplary embodiment of the disclosure may be referred to as a data processing device. Therefore, the disclosure is not particularly limited to the image processing device 100 described above.

If the storage medium 110 is connected to the image processing device 100 according to a wire or wireless method or there is a request for using the storage medium 110 from a user after the storage medium 110 is connected, a bad sector of the storage medium 100 is determined, i.e., a physical space (e.g., a memory space) on which data is actually written is determined as being bad, in a process of writing data to the storage medium 110 or reading written data. The physical space is divided into sectors. Such a “sector” refers to a size of a memory space of the storage medium 110 to which data is written or from which data is read and may be understood as a concept corresponding to a block. For example, if a (data) block which is to be written or read by the user is 512 bytes, a size, i.e., a capacity, of the memory space of the storage medium 110 to which data having such a size is written or from which data having such a size is read is a sector.

The image processing device 100 according to the exemplary embodiment of the disclosure enables the user not to sense whether a bad sector of the storage medium 110 occurs, by immediately processing the bad sector in a runtime in which a program is executed or a connection operation to the storage medium 110 is executed. In other words, since a user who enjoys scheduled recording continuously accesses a bad sector in a process of deleting or re-recording a recorded file when the bad sector occurs, an application stops or is processed as an error, and thus the scheduled recording stops every time. Therefore, the user may not appropriately use a desired function. However, in an exemplary embodiment of the disclosure, this inconvenience may be improved, and thus the bad sector of the storage medium 110 may be transparently managed.

As will be handled later but briefly mentioned, if the storage medium 110 is connected, the image processing device 100 mounts a file system 190 stored in the storage medium 110. For example, the image processing device 100 may execute an additional application to perform a PVR function in case of a TV. When there is a user's request, the image processing device 100 may mount the file system 190 of the storage medium 110. Here, the “mounting” may mean that the file system 190 stored in the storage medium 110 is copied and stored to operate along with an OS of the image processing device 100, and a file of the file system 190 is created to be used by the user. For example, in case of a PC, displaying a file on a screen may be a fine example.

Prior to a detailed description of the image processing device 100, a file system according to an exemplary embodiment of the disclosure may be processed according to two types of methods. In other words, the file system 190 stored in the storage medium 110 may have a structure as shown in FIG. 2 beforehand. In other words, a field for storing error information on the bad sector of the storage medium 110, i.e., an error block 220, may be pre-constituted. In this case, the image processing device 100 determines a bad sector in a runtime of the storage medium 110 and stores (logic) information (e.g., bad inode) on the determined bad sector as error information in the error block 220. If data is to be written, and there is error information on a bad sector referred for writing the data in the error block 220, the bad sector may not be accessed based on this. If the error block 220 which stores the error information is not pre-constituted, the image processing device 100 may generate and use the error block 220 when mounting a file system.

The file system is a set of files or directories in a physical disk area and may be a rule for writing data to the storage medium 110 and using the data. The file system is meta data as a kind of additional data for accessing an actual physical space, i.e., a memory space, of the storage medium 110. In other words, if image data recorded in the actual physical space is physical information, the file system corresponds to logic information. Here, the “logic information” is additional information for accessing physical information. The physical information and the logic information may be mapped on each other by including common information referred to as address information. Through this, the image processing device 100 searches the meta data of the file system for an address of the memory space to be accessed and writes data or reads data by accessing the memory space corresponding to the searched address.

The file system 190 of FIG. 2 according to an exemplary embodiment of the disclosure may have a data structure which is divided into 5 areas, i.e., a boot block 200, a super block 210, the error block (Bad I-NODE) 220, an I-NODE list 230, and a data block 250. Here, a block may be referred to as an area. The boot block 200 may store execution file information of an operating system required in a booting process of an UNIX system. The super block 210 is a data structure which maintains information of the file system and manages information on a type of the file system, a size of a disk block, a name of a device file where the file system is stored, and the like. The error block 220 stores information on bad sectors of the storage medium 110. The I-NODE list 230 is a set of inodes which store information required for a file management. Here, inode includes information on a file and fields storing an address of a disk block allocated to this file. A number of the inode is an index value required for identifying a file, and a configuration of the inode includes 13 index fields storing a position of the disk block, an owner, a size, an access authority, and an access time of the file, and the like. The inode may be allocated when generating the file and may be returned when deleting the file. The directory is a special file which connects a file name familiar to the user and the inode managing the file and includes the number of the inode and the file name. The data block 240 is a set of disk blocks. Here, each block included in a disk block is a minimum unit storing data, for example, may have a data size of 512 bytes.

The image processing device 100 according to the exemplary embodiment of the disclosure may perform slightly different operations when reading data from the storage medium 110 and when recording the data in the storage medium 110. In other words, when reading data recorded in the storage medium 110, the image processing device 100 accesses a physical area, i.e., a particular space of a memory, based on the meta data of the file system. If data is not read, the image processing device 100 manages inode information of the file system related to the corresponding bad sector in the error block 220. Here, the inode information stored in the error block 220 may be physical damage of the corresponding memory space (hereinafter referred to as physical defect) and may be generated by a data processing error (hereinafter referred to as logic badness) of firmware taking charge of a control function of the storage medium 110. Here, since a bad sector caused by logic badness is reusable, the image processing device 100 checks whether the corresponding bad sector is physical badness or logic badness based on error information contained in the error block 220. For this, the image processing device 100 determines a bad type according to a method of recording test data in the bad sector detected as badness and re-reading the recorded test data. If the test data is read as being normal, the bad type is logic badness. If the test data is read as being abnormal, the bad type is physical badness.

After determining the bad type of the bad sector as described above, the image processing device 100 makes a sector, which is determined as physical badness, into a reusable state. In other words, the image processing device 100 leaves merely error information on physical badness in the error block 220 by deleting error information of a bad sector, which is determined as logic badness, from the error block 220. Also, inode information related to the deleted error information is reused by being added to the I-NODE list 230. If the bad sector is determined as physical badness, the image processing device 100 manages error information related to the corresponding sector, in which badness occurs, in the error block 220. The physical damage may ultimately affect a surrounding area thereof, and thus the image processing device 100 may extend the physical damage to a surrounding area of the corresponding sector, in which the error occurs, and manage the surrounding area as badness in this process. Even if the test data is normally recorded and normally read but is determined as being positioned around the bad sector, the test data may be left in the error block 220.

If data is recorded in the storage medium 110, the image processing device 100 blocks an access to a particular sector of the storage medium 110 based on error information (e.g., bad inode) on the physical badness stored in the error block 220. In other words, recording data in a corresponding sector may be regarded as being fundamentally blocked. In this data recording operation, the image processing device 100 may record data by checking the I-NODE list 230 for inode information for accessing a particular memory space of the storage medium 110.

If the determination of the bad sector of the storage medium 110 is completed, the image processing device 100 may re-transmit the file system 190 to the storage medium 110 and re-store the file system 190 in the storage medium 110. Alternatively, the image processing device 100 may update a file system existing in the storage medium 110 by transmitting the file system 190 to the storage medium 110. An operation of processing, e.g., updating, the file system 190 may be performed after an operation requested by the user is completed but may be performed in real time. Therefore, the disclosure may not be particularly to the above-described contents.

The storage medium 110 may include a hard disk, a USB memory, and the like, and may include a portable electronic device such as a smartphone or the like performing a memory function. The storage medium 110 has a plurality of memory spaces, i.e., a plurality of sectors, for recording (or storing) data. The spaces may be respectively classified according to address information. The storage medium 110 also stores a file system for efficiently managing such a space. The file system 190 may be copied and provided when being connected to the image processing device 100. Also, the file system 190 may perform an updating operation through a comparison with a copied file system provided by the image processing device 100.

According to an exemplary embodiment of the disclosure, the storage medium 110 may be a medium which records massive data. In other words, an exemplary embodiment of the disclosure may be more useful for a medium storing TB level data rather than GB level data. The storage medium 110 may include firmware which internally performs a control function. Under this control, the storage medium 110 may perform a data processing operation with the image processing device 100. In this process, the firmware may cause a data processing error, and the storage medium 110 may recognize this case that an error occurs in a particular sector and notify the image processing device 100 of the error.

For example, the storage medium 110 may process a signal with the image processing device 100 based on a Small Computer System Interface (SCSI). In other words, the storage medium 110 may return a response signal to a request signal received from the image processing device 110 by processing a signal according to a standard thereof. For example, if the image processing device 100 requests badness of a particular sector by transmitting a signal formatted based on the SCSI, the storage medium 110 may record information on a bad sector in a particular field (or block) of the received request signal and transmit the information as a response signal to the image processing device 100, and the image processing device 100 may determine badness of the particular sector by reading the information recorded in the corresponding field. This is merely an example, and thus how to determine badness may not particularly limited in an exemplary embodiment of the disclosure.

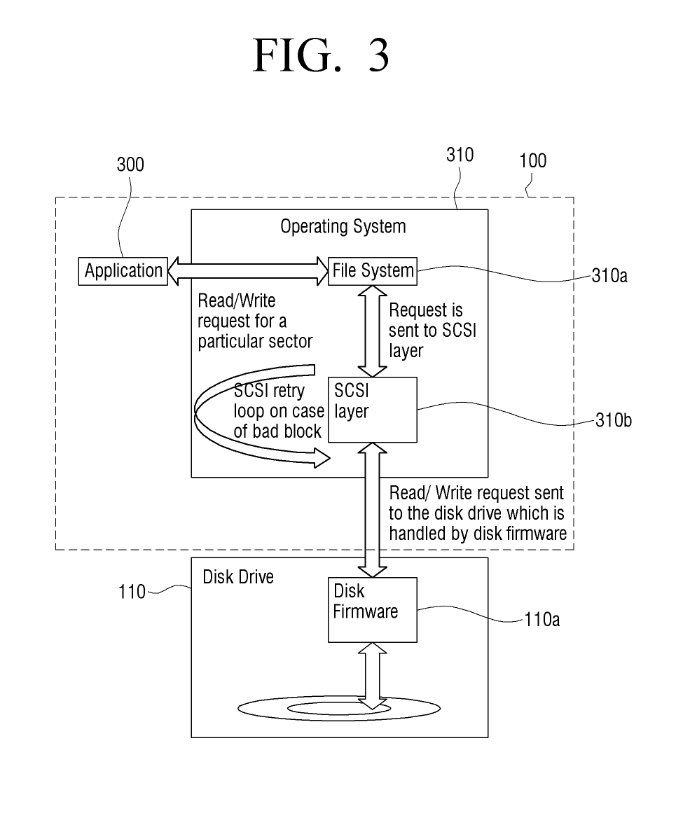

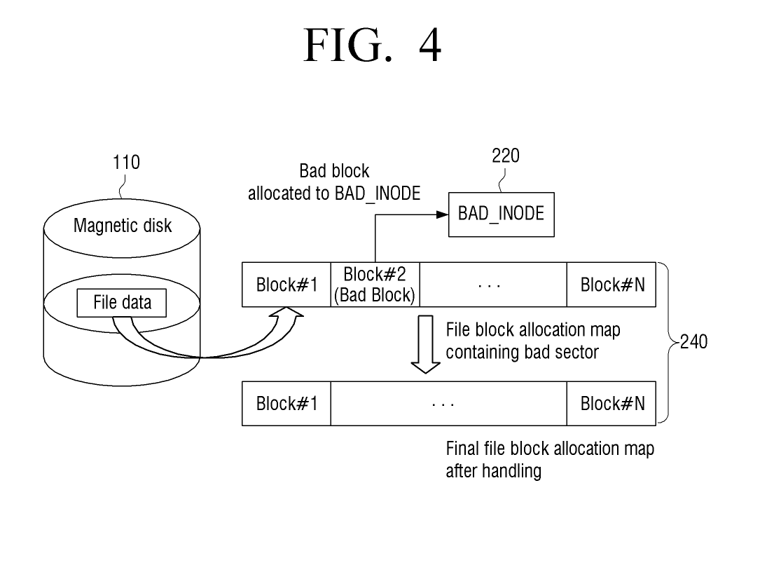

FIG. 3 is a view illustrating a process of a system for processing a bad sector of a storage medium. FIG. 4 is a view illustrating an error occurrence situation.

Referring to FIGS. 3 and 4 along with FIGS. 1 and 2, if a request for performing a PVR function is made from the user, the image processing device 100 according to the exemplary embodiment of the disclosure may execute an application 300 related to the corresponding function.

Prior to this, when the image storage medium 110 is connected, the image processing device 100 may mount the file system 190 stored in the storage medium 110. The mounted file system 190 may be managed by a file system manager 310a of an operating system 310. If the operating system 310 is formed of at least two 2 layers, the file system manager 310a may correspond to a system program layer for processing a file system.

If there is a user request through the application 300, the file system manager 310a may process the corresponding request signal based on a SCSI standard according to an exemplary embodiment of the disclosure. Here, the SCSI corresponds to a kind of hard disk controller as an interface standard which connects peripheral devices. A request signal of the user is processed as a SCSI standard through a SCSI layer 310b for interacting with the storage medium 110 and then transmitted to the storage medium 110. Here, the SCSI layer 310b corresponds to a kernel layer of two layers of the operating system 310.

The storage medium 110 processes the request signal, which is transmitted from the image processing device 100, through an internal firmware 110. In this process, the storage medium 110 transmits state information of a block which is requested to record or read data from the user. Here, the block refers to a size of data requested to record or read data from the user as aforementioned, and the state information refers to whether badness occurs.

As will be described more based on the SCSI, the file system manager 310a of the operating system 310 transmits a request signal (e.g., scsi sense command buffer) to the storage medium 110 and receives state information of a current block as a response signal to the request signal from the storage medium 110 whenever there is reading and/or writing. If an error bit (e.g., a unrecoverable bit) is set to the response signal received from the storage medium 110, the SCSI layer 310 returns an error expressing as a bad block to the file system manager 310a when ending the corresponding block (e.g., end I/O). In other words, the error is notified. In other words, if an error number (e.g., I/O number) expressing a bad block is received from the SCSI layer 310b, the file system manager 310a may determine that the corresponding block is a bad block. Here, the “error number” may be information related to a bad type.

The file system manager 310a pre-generates meta data in the error block 220 referred to as bad inode when mounting a file system. The bad inode is general inode but is set not to be looked up so as not to be seen by the user. In other words, for managing bad blocks, the bad inode may be easily managed by using inode of a general file system, i.e., meta data, without particularly modifying a layout on a disk (e.g., on-disk layout). Since the layout is not modified on the disk, the inode may be embodied in a currently existing file system without issues about compatibility. For example, if a bad block list is added to NTFS, which is a PVR file system, in a layout of a disk, a serious problem occurs, i.e., the bad block list is recognized in a TV but is not recognized in a window PC. Therefore, if a bad block occurs due to generation of bad inode, all bad blocks may be driven into one file, i.e., bad inode.

Here, there is a high possibility that sectors on the periphery of a bad sector will be in weak states (e.g., worn-out states or considerably weak states), and thus the bad sector is required to be blocked from being accessed by the user. Therefore, when a bad block occurs, a file system does not move one block but sends surrounding blocks on both sides of the one block together. Here, the surrounding blocks are mapped on bad inode in extent units not in block units so as to be easily managed. Here, the “extend units” is a collection of blocks where physical blocks continue.

As aforementioned, a bad sector is divided into logic badness and physical badness. The physical badness is badness occurring due to a problem of firmware 110a as shown in FIG. 3 and is a sector which is restorable in rewriting. The physical badness may not be re-mapped on spare blocks of the storage medium 110, and thus a corresponding sector is a sector which may not be permanently accessed (which fails to be read and/or written).

For this reason, the SCSI layer 310b of FIG. 3 determines whether a sector determined as a bad block is physical badness or logic badness and determines whether surrounding blocks moved along with the bad block are bad. This process may be performed by BBM torture thread according to an exemplary embodiment of the disclosure. Here, the “BBM torture thread” is a thread which to determine block candidates (surrounding blocks) as processing badness or returning the block candidates to a free block list so as to enable the user to access the block candidates by evaluating logic badness, physical badness, or the block candidates mapped on bad inode. Here, the “thread” refers to a performance path existing in a processor, i.e., a series of execution codes, when performing a computer program.

All these are performed when the application 300 actually accesses a file, i.e., in a runtime. In other words, all these are performed in an online state which is a state where the user may access the application 300 by mounting the file system 190. Also, such a bad block may be managed in a runtime and thus is performed without stopping an application operation. Like offline BBM, all sectors may not be checked, but error processing may be performed with respect to merely a block which is accessed by the application 300 through a file.

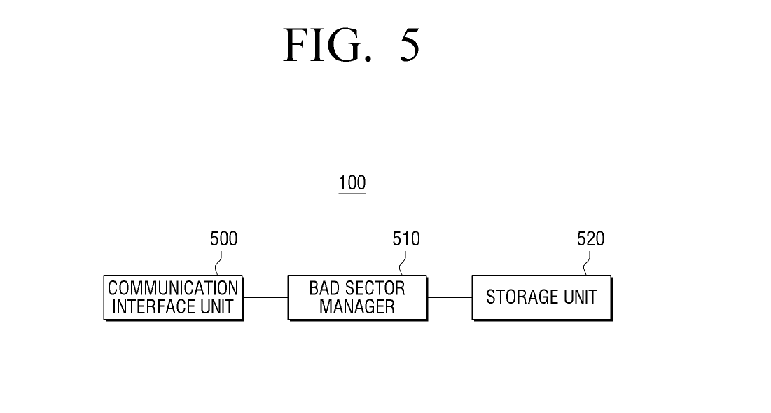

FIG. 5 is a block diagram illustrating a detailed structure of the image processing device shown in FIG. 1.

As shown in FIG. 5, the image processing device 100 according to an exemplary embodiment of the disclosure includes some or all of a communication interface unit 500, a bad sector manager 510, and a storage unit 520.

Here, the “inclusion of some or all” means that some elements such as the storage unit 520 are omitted or integrated into another element such as the bad sector manager 510. All will be described as being included for helping sufficient understanding of the disclosure.

The communication interface unit 500 may be a connector for connecting the image processing device 100 to the storage medium 110 of FIG. 1. Alternatively, the communication interface unit 500 may be a communication module through which the image processing device 100 performs near field communication such as WiFi, Bluetooth, or the like. The image processing device 100 has processed a signal or data with the storage medium 110 according to the SCSI standard for helping understanding of description in the exemplary embodiment of the disclosure but may process the signal or the data according to any method.

The bad sector manager 510 manages a mounted file system. For example, a copy of a file system transmitted from the storage medium 110 may be stored in the storage unit 520 and then managed through a file system manager of an OS. Alternatively, the bad sector manager 510 may store and manage a copy of a file system in an internal memory. Through this, the bad sector manager 510 manages a bad sector of the storage medium 110 in a block requested by the user. Here, as aforementioned, the “management of the bad sector” may mean that inode information of a bad sector determined as being bad, more accurately, determined as physical badness, is stored and managed in an error block of a file system.

The meaning of “storing and managing” may be diverse. The storing and managing may mean that merely error information related to physical badness is left by storing inode information on a newly determined bad sector as error information in an error block and then determining a type of badness. Alternatively, the storing and managing may be understood as storing and updating merely information related to physical badness or referring to error information if there is a request for writing data. Therefore, an operation thereof is not particularly limited.

The bad sector manager 510 may be embodied as software, hardware, or a combination thereof ant thus is not particularly limited thereto. The bad sector manager 510 will be described later in relation to the embodiment of hardware but may be embodied as software in FIG. 5. In other words, a function of the bad sector manager 510 for controlling the communication interface unit 500 and the storage unit 520 and a function of the bad sector manager 520 for managing a bad sector of the storage medium 110 may be embodied as software.

For example, the embodiment of the bad sector manager 510 as software may extensively mean the embodiment of the operating system 310 as described above with reference to FIG. 3 but may narrowly include at least one selected from a system program layer such as the file system manager 310a and a kernel layer such as the SCSI layer 310b which are some thereof.

The storage unit 520 may store various types of information which are processed under control of the bad sector manager 510. The storage unit 520 may be any type of memory such as a nonvolatile ROM, a volatile RAM, or the like. For example, the storage unit 520 may store an application for performing a PVR of a TV, and the stored application may be executed under control of the bad sector manager 510. Also, as aforementioned, the storage unit 520 may store a copy of a file system of the storage medium 110, i.e., may be variously used.

Except for the above-described points, detailed contents related to the communication interface unit 500, the bad sector manager 510, and the storage unit 520 of FIG. 5 are not greatly different from the contents of the image processing device 100 of FIG. 1 and thus are replaced with the contents.

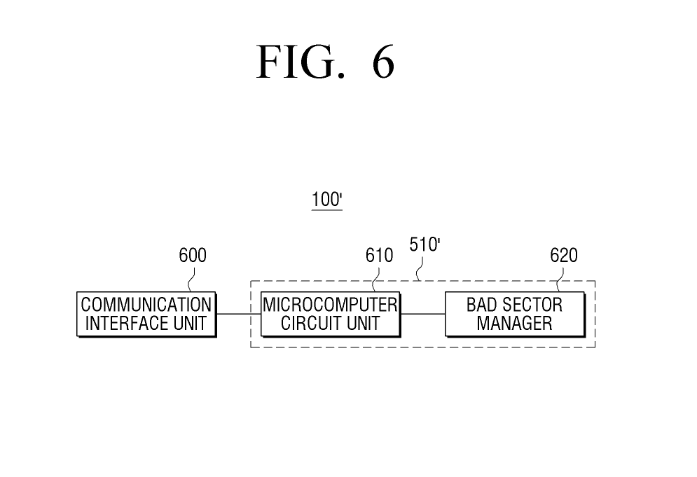

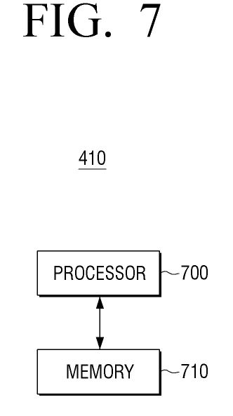

FIG. 6 is a block diagram illustrating another detailed structure of the image processing device shown in FIG. 1. FIG. 7 is a view illustrating a structure of a microcomputer circuit unit shown in FIG. 6.

As shown in FIG. 6, an image processing device 100′ according to another exemplary embodiment of the disclosure includes some or all of a communication interface unit 600, a microcomputer circuit unit 610, and a bad sector manager 620. Here, the “inclusion of some or all” is the same as the foregoing meaning.

When comparing the microcomputer circuit unit 610 and the bad sector manager 620 of FIG. 6 with the bad sector manager 510 of FIG. 5, the bad sector manager 510 is separately constituted as hardware.

In other words, the microcomputer circuit unit 610 may perform merely a control function, and a management of a bad sector may be processed by the bad sector manager 620. The bad sector manager 620 of FIG. 6 may store and execute an operating system and a copy of a file system.

For example, the microcomputer circuit unit 610 shown in FIG. 6 may be a processor 700 of FIG. 7. Therefore, the microcomputer circuit unit 610 may be a CPU, for example, include a control circuit (or a controller), an Arithmetic Logic Unit (ALU), a command interpreter, a register group, and the like. If information related to a bad sector of the storage medium 110 is received through the communication interface unit 600, the microcomputer circuit unit 610 transmits the information to the bad sector manager 620 so as to enable the information to be processed by the bad sector manager 620. Thereafter, when processing a block according to a user request is ended, the microcomputer circuit unit 610 may transmit a copied file system to the storage medium 110 through the communication interface unit 600. Processing information related to a file system may be transmitted to the storage medium 110 and then processed in real time and thus may not be particularly limited thereto.

The microcomputer circuit unit 610 may further include a memory 710 as shown in FIG. 7. In this case, the processor 700 of the image processing device 100 may load and execute programs of the bad sector manager 620 in the memory 710 in an initial operation (e.g., when or after booting). Therefore, a data processing speed becomes faster by that much.

As described above, a method of embodying the image processing device 100 for managing a bad sector of the storage medium 100 is diverse according to the disclosure, and thus the disclosure is not particularly limited to any one method.

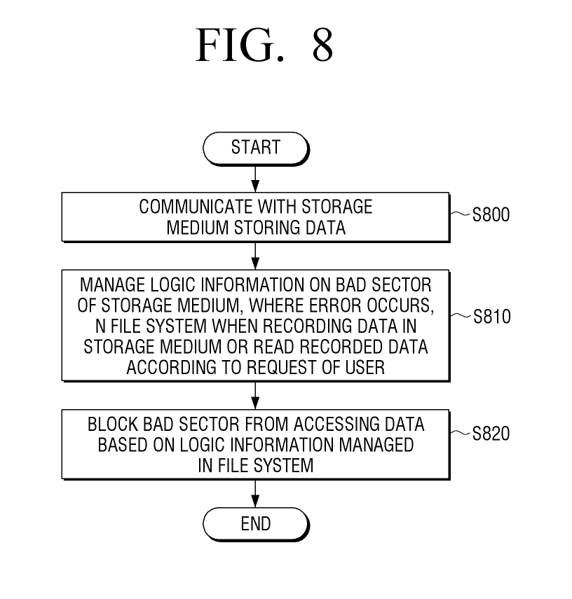

FIG. 8 is a flowchart illustrating a process of operating an image processing device according to an exemplary embodiment of the disclosure.

Referring to FIG. 8 along with FIG. 1 for description convenience, the image processing device 100 according to an exemplary embodiment of the disclosure communicates with the storage medium 110 in operation S800. For this, the image processing device 100 may recognize the storage medium 110. This process may include an operation of mounting a file system stored in the storage medium 110.

In operation S810, when recording data in the storage medium 110 or reading recorded data according to a request of a user, the image processing device 100 stores and manages error information on an error occurrence area of the storage medium 110 in which an error occurs, i.e., a sector of the storage medium 110, in a file system.

In operation S820, the image processing device 100 blocks an access to data in the error occurrence area based on the error information managed in the file system. Here, the “blocking” makes recording or reading of data with respect to a memory space of the storage medium 110, i.e., a sector, permanently impossible.

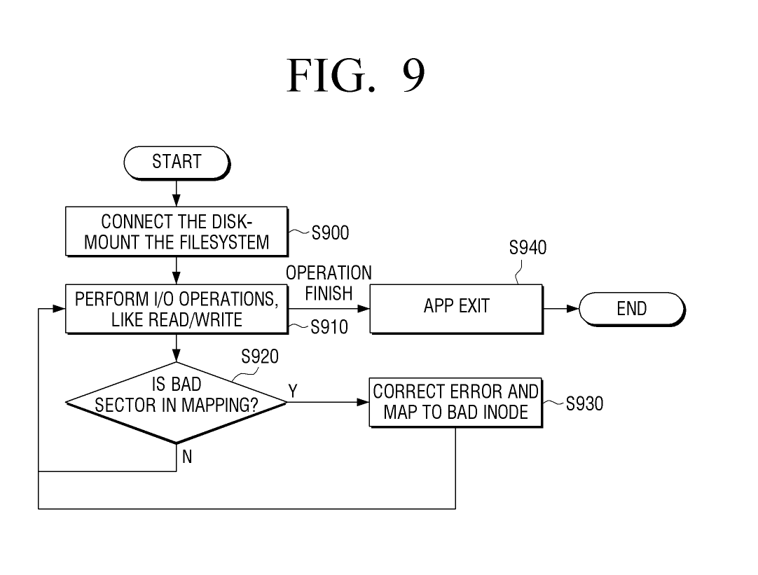

FIG. 9 is a flowchart illustrating a process of operating an image processing device according to another exemplary embodiment of the disclosure.

Referring to FIG. 9 along with FIG. 1 for description convenience, the image processing device 100 according to another exemplary embodiment of the disclosure mounts a file system stored in the storage medium 110 by connecting to the storage medium 110 in operation S900.

In this process, if there is no error block, i.e., a block referred to as bad inode, the image processing device 100 may generate the corresponding block in the file system.

In operation S910, the image processing device 100 performs input/output operations according to an arbitrary block, i.e., a data size, based on a request of a user (e.g., read/write). Here, the input/output operations are related to recording of data or reading of recorded data.

In operations S920 and 930, if a particular sector of the storage medium 110 is determined as being bad, the image processing device 100 classifies the particular sector as the bad sector, determines a bad type based on classified information, and finally manages a bad sector determined as physical badness in bad inode of the file system. The process of determining the bad type may be referred to as “torture thread” according to an exemplary embodiment of the disclosure.

If there is no request from the user any more in operation S910, the image processing device 100 may exit an application for performing a PVR function in operation S940.

The process of operating the image processing device 100 according to the disclosure will be described in more detail with reference to FIG. 9 along with FIGS. 2 through 4.

For example, the file system 190 of a USB type HDD, i.e., a USB HD, may be mounted in the image processing device 100, and a file system manager may generate bad inode, which is the error block 220, in a mounting operation. BBM torture thread may be generated in this process.

The image processing device 100 performs an operation of reading and/or writing a file, i.e., data, in the USB HDD connected by the user application 300.

A second block may be, for example, accessed as shown in FIG. 4 in a process of sequentially inputting and/or outputting blocks of the file system 190. If the second block is detected as bad sector, the SCSI layer 310b of FIG. 3 checks a bit from a response signal (e.g., sense command buffer), and, if an error bit is detected, returns an error number (e.g. an I/O error number) expressing a bad block to the file system manager 310a.

The file system manager 310a recognizes the second block as the bad block, remaps an extent along with surrounding blocks on bad inode in inode of an existing file in extent units, and wakes up BBM torture thread. In other words, a bad type is determined through the BBM torture thread.

In reading, after remapping bad inode, a corresponding logic block is not allocated a physical block in file inode accessed by an existing application but is processed in a hole state. Also, the file system manager 310a may load and return zero data in a response signal (e.g., buffer) according to a hole processing method according to a request of a user for reading an application.

In writing, a new physical block is allocated from a free block list of the file system 190 and is mapped in a logic block after rewriting. Also, an extent where a bad block occurs is remapped in bad inode, i.e., the error block 220.

BBM torture thread executed as a background wakes up by a wake-up request when badness occurs and determines whether a block mapped on bad inode is bad with a writing and/or reading test. Here, data with 0x55 is written and/or read, compared, and swapped so as to be determined by using data filled with 0xaa.

In case of logic badness, the block is returned to the block free list, and merely a block containing physical badness is left in bad inode. Also, if surrounding blocks of a bad block are also determined as being bad by a torture test, the surrounding blocks are left in the bad inode, and blocks which are not bad are returned to the free list.

Since bad blocks are remapped on inode by BBM, the user application 300 may manage the bad blocks so as to enable the bad blocks not to be permanently accessed after deleting and regenerating an existing file.

According to the disclosure, by managing a bad sector occurring when using a HDD disk so as to enable the bad sector not to be accessed by a file system, when a user or product (e.g., a TV, a smartphone, or the like) reading and writing a file, i.e., data, the HDD disk may be used for a long time by not stopping an application due to an I/O error based on an access to the bad sector and pre-blocking an access to a candidate area of an additional bad sector. Also, user convenience may be improved in an embedded product group by improving a response problem of existing offline BBM.

Although all elements constituting exemplary embodiments of the disclosure have been described as being combined into one or combined into one to operate, the disclosure is not limited to the these exemplary embodiments. In other words, all elements may be selectively combined into one to operate within the scope of the disclosure. Also, all elements may be respectively embodied as one independent hardware, but some or all of the elements may be selectively combined to be embodied as a computer program having a program module performing some or all of functions combined in one piece of hardware or a plurality of pieces of hardware. Codes and code segments constituting the computer program may be easily inferred by those skilled in the art. The computer program may be stored on a non-transitory computer readable media, may be read and executed by a computer, and may embody the exemplary embodiments of the disclosure.

The non-transitory computer readable medium is a medium which does not store data temporarily such as a register, cash, and memory but stores data semi-permanently and is readable by devices. More specifically, the aforementioned applications or programs may be stored in the non-transitory computer readable media such as compact disks (CDs), digital video disks (DVDs), hard disks, Blu-ray disks, universal serial buses (USBs), memory cards, and read-only memory (ROM).

The foregoing exemplary embodiments and advantages are merely exemplary and are not to be construed as limiting the disclosure. The present teaching may be readily applied to other types of apparatuses. Also, the description of the exemplary embodiments of the disclosure is intended to be illustrative, and not to limit the scope of the claims, and many alternatives, modifications, and variations will be apparent to those skilled in the art.

1. An operation method for an image processing device connectable to a storage medium storing a file system, the operation method comprising:
communicating with the storage medium;
storing logic information on a bad sector of the storage medium in the file system; and
blocking the bad sector from accessing data based on the logic information when recording data in the storage medium or reading the recorded data according to a request of a user.

2. The operation method of claim 1, further comprising:
based on the file system comprising an error block (bad inode) storing the logic information of the bad sector, generating the error block in the file system when the file system is mounted in the image processing device.

3. The operation method of claim 1, further comprising:
determining a bad type of the bad sector,
wherein managing of the file system comprises managing the logic information of the bad sector having physical badness caused by a physical impact of the storage medium.

4. The operation method of claim 3, wherein the determining of the bad type of the bad sector comprises determining whether the bad type is logic badness caused by an error in data processing,
wherein the operation method further comprises processing the logic information of the bad sector determined as the logic badness in a data accessible state in the file system.

5. The operation method of claim 3, wherein the determining of the bad type of the bad sector comprises determining whether the bad type is logic badness caused by a processing error of data,
wherein the bad type is determined as the logic badness when recording test data in the bad sector and normally reading the recorded test data.

6. An image processing device connectable to a storage medium storing a file system, the image processing device comprising:
a communication interface unit configured to communicate with the storage medium; and
a processor configured to store logic information on a bad sector of the storage medium in the file system and block the bad sector from accessing data based on the logic information when recording data in the storage medium or reading the recorded data according to a request of a user

7. The image processing device of claim 6, wherein the file system comprises an error block (bad inode) storing the logic information of the bad sector.

8. The image processing device of claim 7, wherein the processor generates the error block in the file system when the file system is mounted in the image processing device.

9. The image processing device of claim 6, wherein the processor determines a bad type of the bad sector and manages the logic information of the bad sector when the bad type is physical badness caused by a physical impact of the storage medium.

10. The image processing device of claim 9, wherein the processor further determines whether the bad type is logic badness caused by an error in data processing.

11. The image processing device of claim 10, wherein the processor processes the logic information of the bad sector determined as the logic badness in a data accessible state in the file system.

12. The image processing device of claim 10, wherein the processor determines the bad type as the logic badness when recording test data in the bad sector and normally reading the recorded test data.

13. The image processing device of claim 9, wherein the processor determines the bad type when the processor is in an idle state.

14. The image processing device of claim 9, wherein the processor manages logic information on a surrounding sector of the bad sector determined as the physical badness together.

15. The image processing device of claim 14, wherein a determination as to whether the error occurs is performed with respect to a plurality of normal sectors comprising the bad sector in real time.
